(19) United States
(12) Patent Application Publication
(10) Pub. No.: US 2003/0146974 A1
(43) Pub. Date: Aug. 7, 2003

(54) Street furniture or the like

(76) Inventor: David Barry Murphy, London (GB)

Correspondence Address: St Onge Steward, Johnston & Reens, 986 Bedford Street, Stamford, CT, 06905-5619, US

(21) Appl. No.: 10/275,126

(22) PCT Filed: May 2, 2001
(86) PCT No.: PCT/GB01/01935

(30) Foreign Application Priority Data
May 2, 2000 (GB) 0010557.7

(51) Int. Cl. H04N 7/18; H04N 9/47

(52) U.S. Cl. 348/143; 348/159

(57) ABSTRACT

The present invention relates to a piece of street furniture comprising a structure incorporating a display or advertising unit (7) and a multi-channel closed circuit television security system. The system includes video cameras (CAM₁ . . . . CAM_{N}) located in a camera housing (4) above the display unit (7), and connected to two or more video tape recorders (VCR ₁ . . . VCR_{N}) located in a base storage unit (10) below the display unit (7). The video recorders (VCR) are interconnected, and connected to the outputs of the cameras (CAM), by circuitry associated with switching means (14) which is operable, when one recorder is recording the camera outputs and reaches a predetermined capacity, to cause the other recorder to commence recording the camera outputs, and vice versa. The camera outputs are therefore recorded by the recorders in turn, in a continuous loop.

The present invention relates to a piece of street furniture or like structure which incorporates a display means and a closed circuit television (CCTV) system including at least one video camera. The structure is intended to be mounted in a fixed position accessible or visible to the public, for example in the vicinity of a road, pavement or foot path, car park, or other area, so that the public can view advertising or other material/information displayed by the display means, whilst the CCTV system surveys the adjacent or surrounding area, for example for security purposes.

The structure according to the invention is self-contained in that the CCTV system also includes, located in the structure, means to record and store the camera output. The recordal and storage means preferably operates in a manner analogous to a closed loop, so that the video signals already recorded in a first section or field of the recording medium are stored for a period of time for access/retrieval whilst video signals are being recorded in a further section or field of the medium, whereafter video signals are again recorded in the first section or field whilst the signals recorded in the further section or field are stored, the sequence being repeated continuously.

According to one aspect of the present invention, there is provided a structure for use as a piece of street furniture or the like, which includes display means, and a closed circuit television system comprising at least one camera and means to record and store the camera output, the recordal and storage means including at least two recording devices, for example video recorders or tape decks, which are interconnected, and connected to the output of the or each camera, by circuitry associated with switching means, the switching means being operable, when one of the recording devices is recording the camera output and nears or reaches a predetermined capacity, to cause the other recording device to commence recording the camera output, and vice versa.

With this reverse cascade switching arrangement the video output from the camera(s) is continuously interfaced with and recorded by the recording devices in turn, i.e. in a continuous loop. For example, when one device is recording and the tape or other recording medium of that device is full or nearly full, that device generates a signal (e.g. an “end-of-tape” alarm output or signal) which is used to start the other device recording (e.g by triggering the “record-start” input of the other device), and the first device stops. Then, when the recording medium of the other device is full or nearly full, that device similarly generates a signal, which is used to start the first device recording again, and the further device stops. This sequence or cycling is repeated automatically without the need for human intervention. The switching means thus comprises an interface loop forward and reverse cascade switch.

The recording medium of the currently non-recording device may be accessed, played back, or removed and replaced, as required, without interrupting the recording continuity of CCTV system.

The CCTV system will continue to record endlessly for weeks or months irrespective of the record times/capacities of the individual recording media, e.g. tapes or discs.

The switching means may be an electronic switching device or circuit arrangement which switches the video output of the camera(s) from one recording device to the other. However, this may not be necessary, and the video output from the camera(s) may be permanently connected to both recording devices, if, for example, the internal circuitry of the devices isolates or disconnects these input video signals from the recording heads, etc. when the devices are not in their record mode.

It will be appreciated that more than two recording devices may be incorporated into the system or loop so as to record the video output sequentially and endlessly. Alternatively, the video signals could be recorded in different sections or fields of a common recording medium, such as a CD, DVD, or other recordable and erasable memory, whether digital or analog.

The CCTV system may be a multi-channel closed circuit television (MCCCTV) security or surveillance system including a camera housing located above the display means, and containing a plurality of video cameras having video outputs connected to video recording means mounted in a base housing located below the display means. The recording means has the capacity to record continuously for a period of several days, so that incidents or events which occurred and were recorded and stored previously may be accessed, played back and analyzed.

The recording devices may be video tape recorders (VTRs), such as video cassette recorders (VCRs) which receive time lapse video signals from the cameras of the MCCCTV system. The plurality of signals from the plurality of cameras are recorded on the tape sequentially and cyclically, or on successive or adjacent or parallel fields of the tape, for example via a multi-channel encoder or multiplexer such as a 9 channel multiplexer. Since the recorders are connected to record sequentially in an endless loop, faster time lapse speeds may be used, for example 3 frames per second for each camera, yet an incident or event may be reviewed much later, since, at any instant, the recorders may be storing images recorded over at least 5 and preferably up to 10 days, or even more.

In order that the invention may be more readily understood, reference will now be made to the accompanying drawings, in which:

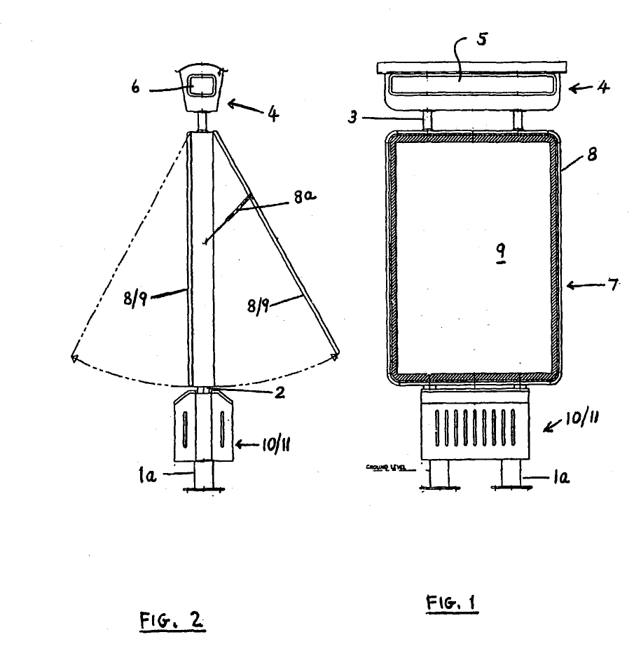

FIG. 1 is a front elevation of a structure embodying the invention;

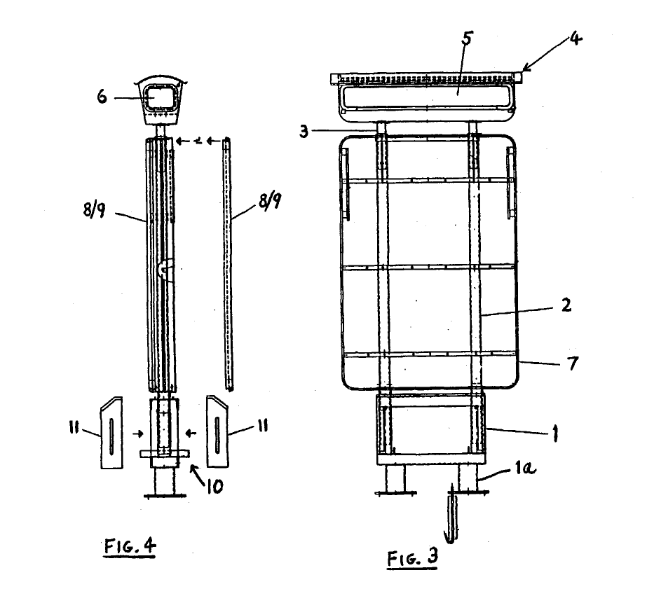

FIG. 2 is a side elevation of the structure with the right-hand (front) door of the display unit shown in its open position and the camera housing doors closed;

FIG. 3 is a view similar to FIG. 1, with the front doors/panels of the camera housing and display unit and base storage unit, and the internal components, omitted for clarity, and showing additional details of the structure;

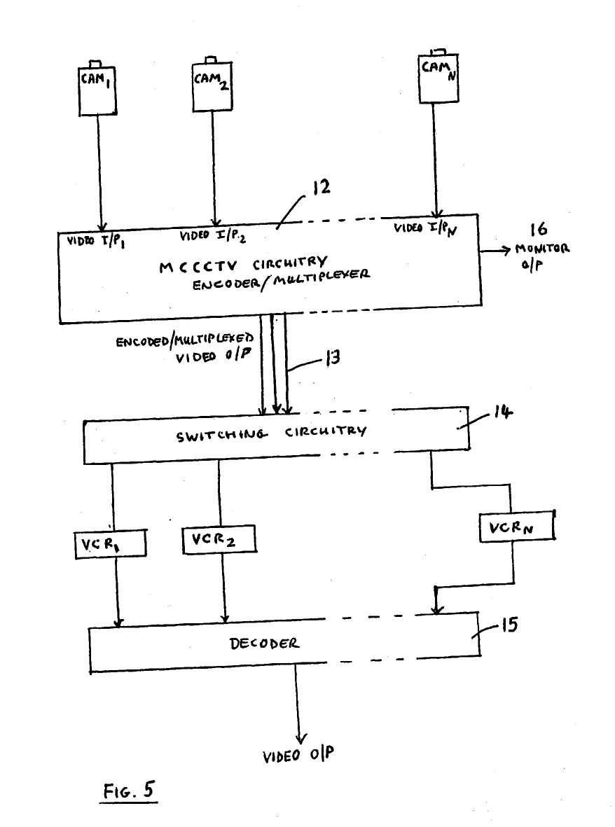

FIG. 4 is a view similar to FIG. 2, with some of the door/panel components shown detailed, and showing additional details of the structure; and

FIG. 5 is a schematic block diagram of the one embodiment of MCCCTV system.

The structure shown in FIGS. 1 to 4 comprises an upright, stand-alone integrated unit which is vandal-and water-resistant/proof. The unit includes a base or base frame 1 having feet 1a which are intended to be anchored to or embedded in the ground. Fixed to the base 1 are vertical frame tubes 2 at the top of which are telescopically adjustable/removable supports 3 carrying a housing 4 containing a plurality of cameras (not shown), for example high definition colour cameras, mounted on rails. The cameras may be arranged in predetermined positions so as, together, to give a combined field of vision around the structure of essentially 360°. Instead of being static or passive, some or all of the cameras could be dynamic, i.e. they could be remotely controlled so as to be adjustable in azimuth and/or elevation, and/or zoom. The camera housing 4 may, for example, contain ten cameras, namely four cameras viewing through each of a pair of toughened glass or perspex side windows 5, and a further two cameras, one viewing through each of a pair of end windows 6. The windows are inclined downwardly, and at least the side windows are incorporated in hinged, upwardly opening access doors.

Mounted on the frame tubes 2 below the camera housing 4 is a display unit or main casing 7 which, in this embodiment, includes a pair of hinged, upwardly opening door assembles 8 incorporating toughened glass panels 9, for example operated or controlled by gas struts 8a at the sides of the doors. The doors, which are lockable, may be opened and closed to permit advertising material such as posters, etc. to be inserted into the main casing 7, and to be removed and replaced when required. The main casing is preferably provided with internal lighting for illuminating the advertising material.

In one non-limiting embodiment, the height of the structure may be of the order of 3 to 4 metres, for example approximately 3.2 metres. The width of the structure may be of the order of 1 to 2 metres, for example 1.3 metres.

The base frame 1 is provided with a base storage unit 10 for the equipment associated with the MCCCTV system, the unit 10 having removable and lockable covers 11. The system equipment includes two or more recording devices, e.g. VTRs such as VCRs, and associated electronic interface loop forward and reverse cascade switching circuitry, not shown in FIGS. 1 to 4, but as described earlier, and as illustrated schematically in FIG. 5.

As shown schematically in FIG. 5, the video outputs I/P₁ . . . I/P_{N} from video cameras CAM₁ . . . CAM_{N} are received by the multi-channel closed circuit television (MCCCTV) circuitry 12 comprising an encoder/multiplexer, whose encoded/multiplexed output 13, i.e. an encoded signal combining the outputs of all the cameras, is applied to the electronic interface loop forward and reverse cascade switching circuitry 14. The switching circuitry 14 connects the video output 13, sequentially, i.e. in cascade, to the recording devices VCR₁ . . . VCR _{N}. For example, the video output 13 may be initially connected to and recorded on VCR₁, until that device generates an “end-of-tape” signal. This triggers another recording device, for example VCR₂ to “record-start”, and triggers the switching circuit 14 to switch the video output 13 to VCR₂, and VCR₁ stops. This sequence is repeated through to VCR_{N} which, when it generates its “end-of-tape” signal, triggers VCR₁ again.

The devices VCR₁ . . . VCR_{N} are thus connected so as to operate automatically in a closed loop without the need for human intervention, as described earlier.

The tapes of the non-recording VCRs may be accessed and played back via decoder 15, which decodes the multiplexed CAM₁ to CAM_{N} signals. Alternatively, the tapes may be removed and replaced, as required, without interrupting the recording continuity of the CCTV system.

In a first configuration, the structure may be completely self-contained and stand-alone. In this configuration, the structure, for example the base storage unit 10/11 will incorporate rechargeable batteries or other internal power supply means for operating the cameras, associated circuitry, VCRs and display illumination if provided. Means, such as solar cells, may be provided to recharge or supplement the internal power supply.

Additionally or alternatively, the structure could be connected to an external power supply, e.g. mains power, where this is readily available in the immediate vicinity. The internal power supply, if incorporated, could then provide back-up.

This configuration possesses the advantage that the structure may be installed where required with the minimum of disturbance to the surrounding environment, i.e. it is only necessary to provide a base anchorage. It is unnecessary to disturb the surrounding ground to install cabling, etc., normally associated with CCTV systems. The structure can be linked into an existing power supply if there is one in the vicinity. In the event that an event or incident occurs which requires investigation, one or both cassettes may be removed from the VCRs in the base storage unit 10/11 and taken away for analysis, whilst replacement cassettes are fitted to the VRCs. Alternatively, means may be provided for accessing/downloading the tapes in situ in the base unit. For example an external monitor such as a VDU, and/or an external VCR, may be plugged into an appropriate port arrangement associated with the equipment in the base storage unit (see for example the monitor O/P 16 in FIG. 5).

In a second configuration, the CCTV system within the structure, e.g. the VCRs, could be connected, for example via underground cabling, to a data transmission line such as a phone line. The system could then be accessed, i.e. phoned up, from a remote location, and at that location connected to a T.V., personal computer, laptop or other processor. The video data stored on the VCRs, or being stored on the VCR, or real time/live action being viewed by the cameras, could then be downloaded, viewed, and if necessary stored, on the processor, etc. Instead of being accessed over land lines, the system could be accessed directly over a radio link, for example mobile phone network or radio telephone.

In a third configuration, the CCTV system within the structure could be connected, for example wired, into an existing analog or digital surveillance system by standard co-axial or optical cables so that the stored (or real time) video data could be accessed when required, via the latter system and, for example, displayed on monitors in the associated control centre.

In a fourth configuration, the CCTCV system could be accessed when required via a radio link.

The various configurations, or features thereof, may be combined.

In any of the remote access configurations, control circuitry may be provided to allow remote control/adjustment of the cameras, VCRs, etc.

It will be understood that various modifications may be made. For example, the configuration of the structure shown in FIGS. 1 to 4, and of the circuitry shown in FIG. 5, may be changed. The numerical values of the dimensions given herein are purely exemplary.

1. A structure for use as a piece of street furniture or the like, which includes display means, and a closed circuit television system comprising at least one camera and means to record and store the camera output, the recordal and storage means including at least two recording devices which are interconnected, and connected to the output of the or each camera, by circuitry associated with switching means, the switching means being operable, when one of the recording devices is recording the camera output and nears or reaches a predetermined capacity, to cause the other, or another, recording device to commence recording the camera output, and vice versa.

2. A structure as claimed in claim 1, wherein the switching means comprises an electronic switching device or circuit arrangement which is operable to switch the video output of the or each camera from one recording device to the other, or another, recording device.

3. A structure as claimed in claim 1 or 2, wherein the operation of the switching means to switch the video output of the or each camera from one recording device to the other, or another, recording device is triggered by said one recording device.

4. A structure as claimed in claim 1, 2 or 3, wherein the television system is a multi-channel closed circuit television (MCCCTV) security or surveillance system including a camera housing located above the display means, and containing a plurality of video cameras having video outputs connected to the video recording devices, the video recording devices being mounted in a base housing located below the display means.

5. A structure as claimed in claim 4, wherein the recording devices are operable to receive time lapse video signals from the cameras of the MCCCTV system, the plurality of signals from the plurality of cameras being recorded on the recording media of the recording devices sequentially and cyclically.

6. A structure as claimed in claim 4, wherein the recording devices are operable to receive time lapse video signals from the cameras of the MCCCTV system, the plurality of signals from the plurality of cameras being recorded on the recording media of the recording devices on successive or adjacent or parallel tracks or fields of the media.

7. A structure as claimed in any preceding claim, wherein the video output from the or each camera is recorded at a time lapse frequency of about 3 frames per second, or higher.

8. A structure as claimed in any preceding claim, wherein the video recording devices are video tape recorders.

9. A structure as claimed in claim 8, wherein the video tape recorders are video cassette recorders.

10. A structure as claimed in any preceding claim, wherein the recording devices are jointly capable of storing images recorded over a period of at least 5 days, and preferably up to at least 10 days.

11. A structure as claimed in any preceding claim, comprising an upright, stand alone integrated unit.
